(19) United States
(12) Patent Application Publication
(10) Pub. No.: US 2024/0109820 A1
(43) Pub. Date: Apr. 4, 2024

(54) AN ORGANIC AGRICULTURAL COMPOSITION

(71) Applicant: Hiteshkumar Anilkant DOSHI, Thane (IN)

(72) Inventor: Hiteshkumar Anilkant DOSHI, Thane (IN)

(21) Appl. No.: 18/262,103

(22) PCT Filed: Jan. 19, 2022
(86) PCT No.: PCT/IB2022/050434

§ 371 Date: Jul. 19, 2023

(30) Foreign Application Priority Data
Jan. 21, 2021 (IN) 202121002881

(51) Int. Cl. C05G 5/27; C05B 17/00; C05G 5/12

(52) U.S. Cl. CPC C05G 5/27; C05B 17/00; C05G 5/12

(57) ABSTRACT

The present invention relates to an organic agricultural composition comprising at least one water insoluble macronutrient in its elemental form or salts or complexes or derivatives or sources thereof and at least one hydrocolloid, wherein the composition is in the granular or wettable powder or suspension form, and wherein the hydrocolloid has viscosity of ≤400 cps at ≤30% (w/w) aqueous dispersion of the hydrocolloid.

The invention also relates to a process of preparing an organic agricultural composition comprising at least one water insoluble macronutrient in its elemental form or salts or complexes or derivatives or sources thereof and at least one hydrocolloid; wherein the composition is in the form of water dispersible granules or spheronised granules or wettable powder or suspension, and wherein the hydrocolloid has viscosity of ≤400 cps at ≤30% (w/w) aqueous dispersion of the hydrocolloid.

### 1. FIELD OF THE INVENTION

The present invention relates to an organic agricultural composition comprising at least one water insoluble macronutrient in its elemental form or salts or complexes or derivatives or sources thereof and at least one hydrocolloid, wherein the hydrocolloid has a viscosity of less than or equal to (≤) 400 cps at less than or equal to (≤) 30% (w/w) aqueous dispersion of the hydrocolloid. The organic agricultural composition is in the form of a granule or wettable powder or suspension and the composition comprises particles in the size range of 0.1 micron to 15 microns.

The invention further relates to a process of preparing an organic agricultural composition comprising at least one water insoluble macronutrient in its elemental form or salts or complexes or derivatives or sources thereof and at least one hydrocolloid; wherein the hydrocolloid has a viscosity of ≤400 cps at ≤30% (w/w) aqueous dispersion of the hydrocolloid; wherein the composition is in the form of water dispersible granule or wettable powder or spheronised granule or suspension.

### 2. BACKGROUND OF THE INVENTION

In describing the embodiment of the invention, specific terminology is chosen for the sake of clarity. However, it is not intended that the invention be limited to the specific terms so selected and it is to be understood that each specific term include all technical equivalents that operate in a similar manner to accomplish a similar purpose.

Current farming practices are challenged with labor shortage, water shortage, demand on high and quality yields. Besides, deteriorating soil health, decreasing fertility of soil, leaching of fertilizers and pesticides in soil and groundwater, macronutrient deficiencies in soil pose long term challenge in farming practices.

One of the root causes of deteriorating soil health and increasing environmental pollution is excessive use of chemical fertilizers and pesticides. Several agrochemical agents are being used at high dosages for long periods of time as fertilizers and for countering pests and diseases. These chemical agents are a constant burden on the environment as they contaminate the soil, water, turf, and other vegetation. In addition to countering pests and diseases, they can be toxic to a host of other organisms including birds, fish, beneficial insects, and non-target plants. Most of the agrochemical agents leach into the soil and groundwater which can end up in drinking water also. The sprays can drift and pollute the air. Further nutrient losses are also a cause for concern due to the economics, as well as due to environmental reasons. Besides, agricultural produce using chemical fertilizers, pesticides, weedicides can potentially cause adverse effect on the health of people and can be correlated to disease conditions in humans.

There is a greater need today to optimize farming and agriculture practices by avoiding the use and application of synthetic chemicals, pesticides, chemical adjuvants and excipients to the soil and crops and thereby reduce the chemical residue burden on the environment.

In view of the same, there is a need to develop an agricultural fertilizer composition, which is devoid of chemicals and provides suitable nutrients to the soil. Such a composition would help in reducing the chemical residue burden on the environment. Also, there is a need for a composition which besides avoiding the addition of chemicals to the soil and the crop, reduces the burden on the farmer, in terms of labor and costs, and is user friendly.

The role of macronutrients as an essential element required for growth and reproduction by plants has been long known. Macronutrient plays an important role in balancing the crop nutrition. Further, it is also known that optimum levels of nutrients are required for normal functioning and growth of the plants and any variance in the nutrient levels may cause overall crop growth and health to decline due to either a deficiency or toxicity. Poor availability of fertilizers or nutrients to the plants results in lack of proper growth resulting in the plants becoming more susceptible to attack by pests.

Besides the low concentration of essential macronutrients in soil, one of the root causes for the deficiency is the low availability of macronutrients in its solubilized form to plant roots. Furthermore, managing the nutrition of crops is difficult due to factors such as carbonate levels in the soil, soil salinity, soil moisture, soil alkalinity, low temperature, and concentration of other elements i.e. ‘competitive plant nutrients’ may also affect the availability of the macronutrients and at times lead to the deficiency of the macronutrients.

Further, the ability of plants to respond to the availability of macronutrients affects both crop yield and the macronutrient concentration in the edible tissues and ultimately affects human nutrition. Therefore, proper nutrition is critical for optimizing the plant nutrition and metabolism, which in turn contributes to the crop yield and quality.

The below table outlines the essential macronutrients and the role of each macronutrient in plants and the signs of deficiency in plants.

| | Uptake by | Role of | |
|---|---|---|---|
| | plants in | macronutrient | Sign of |
| Macronutrient | oxidized form | in Plant | Deficiency |
| Nitrogen | NO₃⁻, | Chlorophyll, amino | Chlorosis (yellowing) of leaves; |
| | NH₄⁺ | acids, proteins | spindly stalks; stunted growth; poor |
| | | | yields |
| Phosphorous | HPO₄²⁻, | DNA/RNA, | Stunted and slow early growth; |
| | H₂PO₄⁻ | ATP, cell membrane | purplish stalks and leaf tips of young |
| | | | plants; weak stalks |
| Potassium | K⁺ | Plant metabolism, | Wilting and scorching of older |
| | | stress response, | leaves; poor quality of fruits and |
| | | regulation of water loss | seeds |
| Magnesium | Mg²⁺ | Photosynthesis, | Chlorosis; Poor quality of fruits; |
| | | chlorophyll | Stunted growth of plants and death of |
| | | | plants |

Though the benefits of macronutrients are well known, its deficiency has become widespread over the past several decades in most of the agricultural areas of the world, resulting in macronutrients being indicated as a limiting factor to improved plant growth, high yield and fertilizer efficiency.

Conventional agricultural compositions are formulated using adjuvants which are either synthetic or prepared through chemical means. These synthetic adjuvants potentially contaminate the soil with undesired chemicals and poses residue related problems, soil deterioration and toxic effect on human beings. Prolonged use of chemicals deteriorates the soil health which eventually results in reduced crop yield. Further, the chemical adjuvants, surfactants, carriers, excipients that are used to formulate the presently available agricultural products can potentially have long term negative effect on the environment and contribute to ground water contamination with far reaching effects on mammalian and aquatic life.

Many of these adjuvants used in the conventional state-of-the-art fertilizers are non-biodegradable and remain in the soil for prolonged period of time, in some cases extending over few months and even years. One of the commonly used surfactants in the preparation of such agricultural compositions are lignin sulphonates. High doses of sodium lignin sulphonate have been found to cause adverse health effects in laboratory animals. In a study with guinea pigs and rabbits administered sodium lignosulfonate at a 1 percent concentration for a two- to six-week period, a high percentage of the animals developed ulcerative colon disease (Marcus and Watts, 1974). Further, sodium lignosulfonate is relatively low in toxicity based on results of tests in laboratory animals, including rats, rabbits, and guinea pigs (Luscombe and Nicholls, 1973; Marcus and Watts, 1974). However, high doses of sodium lignosulfonate have been found to cause adverse health effects in laboratory animals. Rats that were given drinking water containing purified sodium lignosulfonate at a 10 g/100 ml concentration for 16 weeks had skin lesions at the bases of their tails, decreased weight gain, increased leukocyte counts, and increased kidney, spleen, and liver weights (Luscombe and Nicholls, 1973).

While natural lignin is considered to be an important component of secondary cells walls in vascular plants and is the second most abundant plant derived organic substance, as larger volumes of fertilizers and pesticides are applied which employ synthetic lignin sulfonates, the long-term deleterious effects of such surfactants are not known or reported. Further, the sulfur atoms are introduced in irregular pattern in lignin sulfonates leading to sulfonated intermediates which are unable to enter the central metabolic pathways thereby restricting the biodegradation of lignin sulfonates. In addition, the high sulfur content of lignosulfonate can negatively affect the microbial metabolism, thereby hindering lignin degradation. (Asina et. al., Microbial treatment of industrial lignin: Successes, problems and challenges, 2017; Asina, Fnu, “Biodegradation of Lignin by Fungi, Bacteria and Laccases” (2016). Theses and Dissertations.1864.) Lignin sulphonates may persist for 6 months to one year in the soil before they break down. (CPWA, 2005; Selin et al., 1975).

Furthermore, the presently available conventional fertilizers exist in forms, which either do not solubilize or do not disperse adequately. This presents a great challenge to the user and the environment. As these compositions are not completely soluble, they leave behind a residue and vital nutrients are not made available for plant uptake as required in different stages of growth and thus poses a major challenge in agriculture.

Therefore, there is a need for natural fertilizer products or agricultural products that are devoid of synthetic adjuvants like lignin sulphonates, naphthalene sulphonate condensates etc. and yet provide good suspensibility and dispersibility. The use and application of natural (organic) product in farming practice should be in such a way that it not only results in achieving desired crop yield, plant growth, vitality and vigor with reduced burden on environment, but also benefits the farmer financially.

While the prior art(s) and the conventionally available product mandates use of synthetic surfactants to prepare water dispersible granules of macronutrients in order to achieve a well dispersing and suspending product, the inventors for the first time determined that the composition of the present invention can result into water dispersible granules of water insoluble macronutrients with excellent suspensibility and dispersibility without the use of conventional synthetic surfactants. The problem of getting the product readily dispersed and suspended in water is even more pronounced, when water dispersible granules are made at a higher concentration of actives and a very fine particle size. In such circumstances, a very little scope is available for surfactants to coat a much larger surface area of macronutrient particles which would help the product remain suspended and dispersed.

Therefore, there is a need for an agricultural product which provides suitable and adequate nutrients to the soil in a timely manner as per the physiological needs of the plant on one hand and simultaneously eliminates the use of synthetic carriers in the composition, thereby resulting in an environment and user-friendly product.

It is therefore surprising that the inventors have made a composition of water dispersible granules of water insoluble macronutrient with a fine particle size distribution, without employing synthetic surfactants. The present composition instead uses natural materials like hydrocolloid of specific characteristics which not only provide superior physical characteristics over that of conventional products like better suspensibility, dispersibility etc. but also various other benefits to the soil and the plant ecosystem. For instance, the composition of the present invention was found to aid in the correction of soil pH and additionally support microbial action thereby facilitating the availability of the water insoluble macronutrient in a form that can be assimilated by the plants.

The embodiments of the present invention in addition to providing an organic agricultural composition that exhibits superior physical characteristics such as suspensibility, dispersibility, wettability, improved viscosity and stability towards heat, light, temperature, and caking also assists in better uptake and assimilation of ambient nutrient present in the soil.

In addition to the significance stated above, embodiments of the present invention are quite relevant to the current farming practices as it provides an organic agricultural composition which is economical, biodegradable and environment friendly. Further, the organic agricultural composition of the present invention comprising at least one water insoluble macronutrient and at least one hydrocolloid does not leave any chemical residue in the environment, and helps improve the fertility of soil and making the plants strong from inside.

### 3. SUMMARY OF THE INVENTION

The invention relates to an organic agricultural composition, comprising at least one water insoluble macronutrient in its elemental form or salts or complexes or derivatives or sources thereof and at least one hydrocolloid; wherein the hydrocolloid has a viscosity of ≤400 cps at ≤30% (w/w) aqueous dispersion of the hydrocolloid; wherein the composition comprises particles in the size range of 0.1 micron to 15 microns. The organic agricultural composition is in the form of granule or suspension or wettable powder.

The invention also relates to a process for preparing an organic agricultural composition comprising at least one water insoluble macronutrient in its elemental form or salts or complexes or derivatives or sources thereof and at least one hydrocolloid; wherein the hydrocolloid has a viscosity of ≤400 cps at ≤30% (w/w) aqueous dispersion of the hydrocolloid; wherein the composition is in the form of granule or suspension or wettable powder and the composition comprises particles in the size range of 0.1 micron to 15 microns.

The process of preparing an organic agricultural composition in the form of water dispersible granule, comprises:
a. milling blend of at least one water insoluble macronutrient in its elemental form or salts or complexes or derivatives or sources thereof, water and at least one hydrocolloid to obtain a slurry or wet mix with a particle size of 0.1 microns to 15 microns; wherein the hydrocolloid has a viscosity of ≤400 cps at ≤30% (w/w) aqueous dispersion of the hydrocolloid; and
b. drying the wet mix to obtain the composition in the form of water dispersible granules; wherein the granules of the composition comprise of granules in size range of 0.05 to 2.5 mm.

The process of preparing an organic agricultural composition in the form of spheronised granule, comprises:
a. milling blend of at least one water insoluble macronutrient in its elemental form or salts or complexes or derivatives or sources thereof, water and at least one hydrocolloid to obtain a slurry or wet mix with a particle size of 0.1 micron to 15 microns; wherein the hydrocolloid has a viscosity of ≤400 cps at ≤30% (w/w) aqueous dispersion of the hydrocolloid;
b. drying the wet mix to obtain the composition in the form of water dispersible granule; wherein the granules of the composition comprise of granules in size range of 0.05 to 2.5 mm; and
c. water is added to the dry composition of step (b), the mixture is blended to obtain a wet mass, which is then extruded through an extruder to obtain the extruded granules in a size range of 0.05 mm to 6 mm; or agglomerating the wet mix or dry composition obtained in step (b) in an agglomerator to obtain granular composition in a size range of 0.05 mm to 6 mm.

The process of preparation of an organic agricultural in the form of suspension, comprising:
a. homogenizing mixture of at least one water insoluble macronutrient in its elemental form or salts or complexes or derivatives or sources thereof, a liquid vehicle and at least one hydrocolloid; wherein the hydrocolloid has a viscosity of ≤400 cps at ≤30% (w/w) aqueous dispersion of the hydrocolloid; and
b. wet milling the obtained suspension to provide composition with a particle size range of 0.1 micron to 15 microns.

### 4. DETAILED DESCRIPTION OF THE INVENTION

In describing the embodiment of the invention, specific terminology is chosen for the sake of clarity. However, it is not intended that the invention be limited to the specific terms so selected and it is to be understood that such specific terms include all technical equivalents that operate in a similar manner to accomplish a similar purpose. It is understood that any numerical range recited herein is intended to include all subranges subsumed. Also, unless denoted otherwise percentage of components in a composition are presented as weight percent.

The terms “a” or “an”, as used herein, are defined as one or more than one. The terms “including” and/or “having”, as used herein, are defined as comprising (i.e., open language).

Granules refers mainly to solid granules. The granules refer to water dispersible granules, extruded granules or spheronised granules or pellets. The spheronised granules also refers to broadcast granules or water disintegrable granules. As described herein, “GR” refers to extruded granules or spheronised granules or pellets.

A water dispersible granule is defined as a formulation which disperses or dissolves readily when added to water to give a fine particle suspension. As described herein, “WG” or “WDG” refer to water dispersible granules.

An organic suspension or ‘Suspension’ encompasses, “aqueous suspension” or aqueous dispersion” or “suspension concentrate (SC)” or “suspo-emulsion” or a “liquid suspension” composition. The suspension is defined as composition wherein solid particles are dispersed or suspended in a liquid. The liquid as a vehicle can be water and/or a water miscible solvent. The water miscible solvent is environmentally safe.

As defined herein, WP refers to a wettable powder, which can be a powder formulation to be applied as a suspension after dispersion in water.

Organic agricultural composition is defined as a composition wherein, the composition comprises ingredients of natural origin or ingredients that are certifiable as organic.

Macronutrients used in the composition refers to nutrients that are needed in larger amounts to achieve optimum plant growth. The macronutrients are water insoluble and in their elemental form or salts or complexes or derivatives or sources thereof. The water insoluble macronutrients can also be in the form of ores or from natural sources thereof.

Hydrocolloid used in the composition refers to substances with affinity to water and also encompasses ‘gum’. The hydrocolloids used in the composition are water-binding colloids of natural origin including botanical, animal, or microbial origin.

Hydrocolloids are long chain polymers of polysaccharides characterised by their property of forming viscous dispersions and/or gels when dispersed in water. According to an embodiment, the hydrocolloids are heterogeneous group of polysaccharides and proteins. Hydrocolloids are known in the art for its use as gelling agent, thickener or stabilizer in healthcare, personal care or food industry.

Although the use of hydrocolloids as gelling agents, thickeners or stabilizers are known in the art, it was surprisingly determined by the inventors that when the hydrocolloid has a viscosity of ≤400 cps at ≤30% (w/w) aqueous dispersion of the hydrocolloid, when combined with at least one macronutrient in its elemental form or salts or complexes or derivatives or sources thereof exhibited unexpected nutritional effect.

Surprisingly, the inventors of the present application determined that when at least one water insoluble macronutrient in its elemental form or salts or complexes or derivatives or sources thereof is combined with at least one hydrocolloid with a viscosity of ≤400 cps at ≤30% (w/w) aqueous dispersion of the hydrocolloid, in an effective amount at a specific particle size range, it demonstrates excellent suspensibility, dispersibility in water and soil moisture, leading to excellent field efficacy in terms of improved yield and plant vigor.

The inventors of the present application also determined that at least one water insoluble macronutrient in its elemental form or salts or complexes or derivatives or sources thereof when combined with at least one hydrocolloid with a viscosity of ≤400 cps at ≤30% (w/w) aqueous dispersion of the hydrocolloid in an effective amount at a specific particle size demonstrates quick conversion of macronutrient to its solubilized form to be available for ready uptake by the plants. In addition, the composition comprising particles in the size range of 0.1 micron to 15 microns demonstrates superior suspensibility and dispersibility thereby enabling it to be applied through different means like drip and sprinkler irrigation. The water insoluble macronutrients present in the composition can be applied uniformly and effectively to the soil and the plant rhizosphere thus providing better nutrient use efficiency over conventional products.

It has surprisingly been found that loading of at least one water insoluble macronutrient in its elemental form or salts or complexes or derivatives or sources thereof at an effective amount in combination with at least one hydrocolloid helped reduce the dependency on chemical adjuvants and excipients, further reducing toxicity caused to environment and humans, and avoid subsequent use of chemicals, and promote better plant health and yield.

It has surprisingly been found that when hydrocolloid with a viscosity of ≤400 cps at ≤30% aqueous dispersion of the hydrocolloid is used in an effective amount with specific concentration of at least one water insoluble macronutrient besides providing binding, gelling or thickening properties, exhibited unexpected improvement in dispersibility, suspensibility and emulsifying properties of the composition, thereby obviating the use of chemical agents such as dispersing agents, wetting agents, chemical surfactants and emulsifying agents which are chemical in nature. Further, the inventors also found that the hydrocolloid provides stable structure to the composition and prevents sedimentation of the macronutrient particles even after prolonged storage.

The inventors of the present invention found that hydrocolloids with viscosity of ≤400 cps at ≤30% aqueous dispersion for granular organic agricultural composition are selected in such a way that the hydrocolloid wets macronutrient but does not form a viscous gel in water. For example, hydrocolloids like Xanthan gum, Almond gum and Katira gum are excluded for the purposes of the granular organic composition as it forms a viscous gel in water at a concentration of 0.1% and does not wet macronutrient. Also, hydrocolloids such as Gellan gum and Dammar gum are excluded for the granular organic composition as it does not wet macronutrient.

Water insoluble macronutrient in its elemental form or salts or complexes or derivatives or sources thereof is an essential active ingredient present in the organic agricultural composition and used in a specific concentration in combination with at least one hydrocolloid in a specific concentration provides a more sustainable and ecological approach in agriculture for crop protection and nutrition; wherein the hydrocolloid has a viscosity of ≤400 cps at ≤30% (w/w) aqueous dispersion of the hydrocolloid. Further, the combination of at least one hydrocolloid with at least one water insoluble macronutrient in its elemental form or salts or complexes or derivatives or sources thereof attributed to enhance certain soil parameters, including in particular correcting its pH by shifting the pH of the soil towards neutral or acidic values for alkaline soils. The correction of the soil pH value helps solubilize the macronutrients and thereby helps in better uptake of macronutrients by plants.

In addition to the nutritional aspect of the composition of the present invention, the inventors surprisingly determined that the composition comprising at least one water insoluble macronutrient in its elemental form or salts or complexes or derivatives or sources thereof and at least one hydrocolloid in an effective amount in the form of suspension or granules provides improved plant growth and strengthens the plant, thereby prevents fungicidal and pest infections resulting in better yield, when the particles in the composition are present in the size range of 0.1 micron to 15 microns; wherein the hydrocolloid has a viscosity of ≤400 cps at ≤30% (w/w) aqueous dispersion of the hydrocolloid.

The inventors found that the composition of the present invention provides a stable organic ecological product which is a combination of at least one water insoluble macronutrient and at least one hydrocolloid in an effective amount. The granular composition exhibits excellent suspensibility and dispersibility of the particles which remain suspended in water for prolonged period of time when the granules are immersed in water. As a consequence, the product does not exhibit clogging of nozzles which is seen in powder-based compositions or even conventional compositions that employ chemical adjuvants like lignin sulphonates, naphthalene sulphonate condensates etc.

The inventors have surprisingly found that in addition to eliminating synthetic chemical adjuvants and surfactants, the composition of the present invention also supports soil microbial activity that facilitates the availability of the macronutrients in a form that can be assimilated by the plants, enhances the nutritional value of soil, and consequently, improves and enhances the crop health.

Further, the inventors found that the composition of the present invention containing natural product, hydrocolloid, is safe for environment, humans and animals. Consequently, the composition eliminates the residual effects and toxicity problem posed by the use of the conventional chemical adjuvants and surfactants.

The inventors also found that the agricultural composition in the form of suspension or granules comprising particles in the size range of 0.1 micron to 15 micron enhances the physical nature of the formulation by providing improved suspensibility, dispersibility, viscosity, instant dispersion of macronutrients on application via soil or foliar route resulting in strengthening and fortification of crops and prevent pest and disease occurrence. The fine particle size of the composition in turn increases the surface area of macronutrient particles and also enables the product to cover wider surface area thus enabling bio-effectiveness at substantially lower dosage.

Thus, the present invention relates to an organic agricultural composition comprising at least one water insoluble macronutrient in its elemental form or salts or complexes or derivatives or sources thereof, and at least one hydrocolloid, wherein the composition comprises particles in the size range of 0.1 microns to 15 microns. The hydrocolloid has a viscosity of ≤400 cps at ≤30% aqueous dispersion of the hydrocolloid.

According to an embodiment the water insoluble macronutrient is selected from nitrogen, phosphorous, potassium, and magnesium in its elemental form or salts or complexes or derivatives or sources thereof. The macronutrients can also be in chelated or non-chelated form. According to an embodiment, the macronutrient in the composition can also be in the form of minerals. The macronutrient can also be in the form of ores. The ores can be oxide ores; carbonate ores; sulphide ores; or halide ores. The salts of macronutrient include water insoluble salts. However, the macronutrients listed hereinabove are exemplary and not meant to limit the scope of the invention.

According to an embodiment the water-insoluble macronutrients comprises of
magnesium carbonate, magnesium oxide; magnesium hydroxide (milk of magnesia); magnesium silicate, magnesium trisilicate
Nitrogen-containing compounds, proteinates, animal sourced or plant sourced proteins, sea weeds, algae.
Rock phosphate
Potassium aluminosilicate, feldspar

According to an embodiment the macronutrient in the composition can also be in the form of minerals; wherein the minerals comprises:
Magnesium ores: Periclase; Brucite; Sellaite; Kotoite; Pertsevite; Suanite; Magnesite; Szaibelyite; Neighborite
Phosphorous ores: rock phosphate, Variscite
Potassium ores: Feldspar; Orthoclase; Sanidine; Microcline; Anorthoclase; Variscite, Struvite, Leucite.

However, the above list of macronutrients is exemplary and not meant to limit the scope of the invention.

The hydrocolloid used in the organic agricultural composition is selected such that the aqueous dispersion of the hydrocolloid at a concentration of ≤30% has a viscosity of less than or equal to 400 cps. For instance, the hydrocolloid is selected such that when 30 grams of the hydrocolloid is dispersed in 70 grams of water, the dispersion has a viscosity of equal to or less than 400 cps. The viscosity of hydrocolloids at ≤30% aqueous dispersion of the hydrocolloid is measured by Brookfield viscometer for instance. The inventors also found that the composition of at least one water insoluble macronutrient with hydrocolloids at a concentration of ≤30% having viscosity of less than or equal to 400 cps does not result in gelation or formation of sticky mass during milling. As a consequence, the milled composition can be dried to obtain agglomerated particles i.e. water dispersible granules.

The hydrocolloid used in the organic agricultural composition are water-binding colloids of natural origin including botanical, animal, or microbial origin.

The hydrocolloid used in the organic agricultural composition is anionic, cationic, non-ionic, amphoteric or hydrophobic hydrocolloid.

The hydrocolloid used in the organic agricultural composition also possesses emulsification properties.

According to an embodiment the hydrocolloids have the ability to reduce the surface tension of water and thereby enhances the wettability of macronutrients.

According to an embodiment, the hydrocolloid is selected such that it contains a protein.

According to an embodiment the hydrocolloids comprises gum arabic, gum karaya, gum ghatti (gum dhawada), larch gum, collagen (fish), Albizia gum, Abelmoschus gum, Almond gum, Bhara gum, Cashew gum, Cordio gum, Grewia gum, Hakea gum, Khaya gum, Katira gum, Kondagogu gum, Leucaena, seed gum, Malva nut gum, Mucuna gum, Moringa gum, Neem gum, Sesbanic gum. Preferably, the hydrocolloid is anionic hydrocolloid selected from gum arabic, gum karaya, gum ghatti, neem gum and moringa gum. However, the above list of hydrocolloids is exemplary and not meant to limit the scope of the invention.

The organic agricultural composition comprises particles in the size range of 0.1 micron to 15 microns. The inventors of the present invention determined that uptake of macronutrient is better when macronutrients are available to the crops at a particle size range of about 0.1 to 15 microns. Thus, the particle size range of 0.1 to 15 microns of the organic agricultural composition was found to be important not only in terms of ease of application but also in terms of efficacy.

The organic agricultural composition is in the form of granules or suspension or wettable powder.

The granular organic agricultural composition is in the form of either water dispersible granules, extruded granules, spheronised granules, or pellets.

The organic agricultural composition has granules in the size range of 0.05 mm to 6 mm which disperses into particles in the size range of 0.1 micron to 15 microns.

According to an embodiment, wherein the organic agricultural composition is in the form of granules, the composition comprises at least one water insoluble macronutrient in its elemental form or salts or complexes or derivatives or sources thereof in the range of 0.1% w/w to 95% w/w of the total composition, and at least one hydrocolloid in the range of 0.1% w/w to 40% w/w of the total composition; wherein the hydrocolloid has a viscosity of ≤400 cps at ≤30% (w/w) aqueous dispersion of the hydrocolloid.

According to further embodiment, at least one water insoluble macronutrient is present in the range of 0.1% w/w to 95% w/w of the total composition. According to further embodiment, at least one water insoluble macronutrient is present in the range of 0.1% w/w to 90% w/w of the total composition. According to further embodiment, at least one water insoluble macronutrient is present in the range of 0.1% w/w to 80% w/w of the total composition. According to further embodiment, at least one water insoluble macronutrient is present in the range of 0.1% w/w to 70% w/w of the total composition. According to further embodiment, at least one water insoluble macronutrient is present in the range of 0.1% w/w to 60% w/w of the total composition. According to further embodiment, at least one water insoluble macronutrient is present in the range of 0.1% w/w to 50% w/w of the total composition. According to further embodiment, at least one water insoluble macronutrient is present in the range of 0.1% w/w to 40% w/w of the total composition. According to further embodiment, at least one water insoluble macronutrient is present in the range of 0.1% w/w to 30% w/w of the total composition. According to further embodiment, at least one water insoluble macronutrient is present in the range of 0.1% w/w to 20% w/w of the total composition. According to further embodiment, at least one water insoluble macronutrient is present in the range of 0.1% w/w to 10% w/w of the total composition.

According to further embodiment, at least one hydrocolloid is present in the range of 0.1% w/w to 40% w/w of the total composition. According to further embodiment, at least one hydrocolloid is present in the range of 0.1% w/w to 30% w/w of the total composition. According to further embodiment, at least one hydrocolloid is present in the range of 0.1% w/w to 20% w/w of the total composition. According to further embodiment, at least one hydrocolloid is present in the range of 0.1% w/w to 10% w/w of the total composition.

According to an embodiment, wherein the organic agricultural composition is in the form of suspension, the composition comprises at least one macronutrient in its elemental form or salts or complexes or derivatives or sources thereof in the range of 0.1% w/w to 70% w/w of the total composition, and at least one hydrocolloid in the range of 0.1% w/w to 30% w/w of the total composition; wherein the hydrocolloid has a viscosity of ≤400 cps at ≤30% (w/w) aqueous dispersion of the hydrocolloid.

According to further embodiment, at least one water insoluble macronutrient is present in the range of 0.1% w/w to 70% w/w of the total composition. According to further embodiment, at least one water insoluble macronutrient is present in the range of 0.1% w/w to 60% w/w of the total composition. According to further embodiment, at least one water insoluble macronutrient is present in the range of 0.1% w/w to 50% w/w of the total composition. According to further embodiment, at least one water insoluble macronutrient is present in the range of 0.1% w/w to 40% w/w of the total composition. According to further embodiment, at least one water insoluble macronutrient is present in the range of 0.1% w/w to 30% w/w of the total composition. According to further embodiment, at least one water insoluble macronutrient is present in the range of 0.1% w/w to 20% w/w of the total composition. According to further embodiment, at least one water insoluble macronutrient is present in the range of 0.1% w/w to 10% w/w of the total composition.

According to further embodiment, at least one hydrocolloid is present in the range of 0.1% w/w to 30% w/w of the total composition. According to further embodiment, at least one hydrocolloid is present in the range of 0.1% w/w to 20% w/w of the total composition. According to further embodiment, at least one hydrocolloid is present in the range of 0.1% w/w to 10% w/w of the total composition.

According to an embodiment, the hydrocolloid has a viscosity of ≤400 cps at ≤30% (w/w) aqueous dispersion of the hydrocolloid. According to further embodiment, the hydrocolloid has a viscosity of ≤300 cps at ≤30% (w/w) aqueous dispersion of the hydrocolloid. According to further embodiment, the hydrocolloid has a viscosity of ≤200 cps at ≤30% (w/w) aqueous dispersion of the hydrocolloid. According to further embodiment, the hydrocolloid has a viscosity of ≤100 cps at ≤30% (w/w) aqueous dispersion of the hydrocolloid.

According to an embodiment, the organic agricultural composition comprises particles in the size range of 0.1 microns to 15 microns, preferably in the particle size range of 0.1 microns to 10 microns.

According to a further embodiment, the organic agricultural composition comprises particles with a particle size distribution (D90) of less than 15 microns, and particle size distribution (D50) of less than 10 microns.

According to an embodiment, the organic agricultural composition is in the form of spheronised granules, wherein the granules are in the size range of 0.05 to 6 mm, preferably in the size range of 0.05 to 5 mm, preferably in the size range of 0.05 to 4 mm, preferably in the size range of 0.05 to 3 mm, preferably in the size range of 0.05 to 2.5 mm. The granules disperse into particles in the size range of 0.1 micron to 15 microns.

According to an embodiment, the organic agricultural composition is in the form of water dispersible granules, wherein the granules are in the size range of 0.05 to 2.5 mm, preferably in the size range of 0.05 to 2 mm, preferably in the size range of 0.05 to 1.5 mm, preferably in the size range of 0.05 to 1 mm, preferably in the size range of 0.05 to 0.5 mm. The granules disperse into particles in the size range of 0.1 micron to 15 microns.

According to an embodiment, the organic agricultural composition further comprises at least one additional active ingredient in the range of 0.1-70% by weight of the total composition and is selected from biostimulants, plant growth regulator, pesticidal actives, fertilizers or mixtures thereof.

According to an embodiment, the plant growth promoter can further comprise humic acid, ascorbic acid, fulvic acid, lactic acid, oxalic acid, phytic acid, fumaric acid, gibberellins, auxins, citric acid, or mixtures thereof. However, the above list of plant growth promoter is exemplary and not meant to limit the scope of the invention.

According to an embodiment, the organic agricultural composition can further comprise at least one agrochemically acceptable excipient selected from structuring agents, surfactants, binders or binding agents, disintegrating agents, fillers or carriers or diluents, spreading agents, coating agents, buffers or pH adjusters or neutralizing agents, anticaking agents, antifoaming agents or defoamers, penetrants, preservatives, stabilizers, pigments, colorants, structuring agents, chelating or complexing or sequestering agents, anti-settling agents, thickeners, suspending agents or suspension aid agents, viscosity modifiers, tackifiers, humectants, rheology modifiers, sticking agents, anti-freezing agent or freeze point depressants, solvents, water soluble inerts and mixtures thereof. However, those skilled in the art will appreciate that it is possible to utilize additional agrochemically acceptable excipients without departing from the scope of the present invention.

According to an embodiment, the organic agricultural composition in the form of granules further comprises at least one agrochemical excipient selected from wetting agents, surfactant, emulsifiers, wetting agents, dispersing agents, binders or fillers or carriers or diluent, disintegrating agent, buffer or pH adjuster or neutralizing agent, antifoaming agent, anti-settling agents, anticaking agent, penetrating agent, sticking agent, tackifier, pigments, colorants, stabilizers, water soluble inerts, and mixtures thereof. However, those skilled in the art will appreciate that it is possible to utilize additional agrochemically acceptable excipients without departing from the scope of the present invention.

According to an embodiment, the organic agricultural in the form of suspension further comprises at least one agrochemical excipient selected from one structuring agent, surfactants, humectants, solvents, water miscible solvents, spreading agent, suspending agents or suspension aid or anti-settling, penetrating agent, sticking agents, drift reducing agents, preservatives, stabilizers, buffers or pH adjusters or neutralizing agents, antifreezing agent or freeze point depressants, antifoaming agents. However, those skilled in the art will appreciate that it is possible to utilize additional agrochemically acceptable excipients without departing from the scope of the present invention.

According to an embodiment, the agrochemically acceptable excipient is present in the range of from 0.1% w/w to 90% w/w of the total composition. According to a further embodiment, the agrochemically acceptable excipient is present in the range of from 0.1% w/w to 80% w/w of the total composition. According to a further embodiment, the agrochemically acceptable excipient is present in the range of from 0.1% w/w to 70% w/w of the total composition. According to a further embodiment, the agrochemically acceptable excipient is present in the range of from 0.1% w/w to 60% w/w of the total composition. According to a further embodiment, the agrochemically acceptable excipient is present in the range of from 0.1% w/w to 50% w/w of the total composition. According to a further embodiment, the agrochemically acceptable excipient is present in the range of from 0.1% w/w to 40% w/w of the total composition. According to a further embodiment, the agrochemically acceptable excipient is present in the range of from 0.1% w/w to 30% w/w of the total composition. According to a further embodiment, the agrochemically acceptable excipient is present in the range of from 0.1% w/w to 20% w/w of the total composition. According to a further embodiment, the agrochemically acceptable excipient is present in the range of from 0.1% w/w to 10% w/w of the total composition.

According to an embodiment, the surfactant is an ‘organic surfactant’ and refers to surfactants that are of natural origin or are certifiable as organic.

According to a further embodiment, the organic surfactant further comprises saponins such as Shikakai, Horse-chestnut, Oat, Sugar beet (leaves), Quinoa, Chickpea, Saffron crocus, Soybean, Licorice, Ivy, Alfalfa, Chinese ginseng, American ginseng, Green pea, Milkwort, Primula, Quillaja bark (LATAM), Reetha, Soapwort, Sarsaparilla, Fenugreek, soap nut, aritha, or Yucca as an extract or powdered form thereof. However, the above list of organic surfactants and saponins are exemplary and not meant to limit the scope of the invention. Further, those skilled in the art will appreciate that it is possible to utilize other conventionally known organic surfactants without departing from the scope of the present invention. The organic surfactants are commercially manufactured and available through various companies.

According to a further embodiment, the composition can comprise natural diluents. According to a further embodiment, natural diluents can comprise water soluble substances. For example, natural diluents comprise water soluble minerals or salts such as sulphates of sodium or potassium; or sodium chloride, or potassium chloride.

According to an embodiment, the binding agents or binders which are used in the organic agricultural composition, comprises one or more of lactose, water soluble cellulose derivatives, starch, dextrins, bentonite, carbohydrates such as monosaccharides, disaccharides, oligosaccharides and polysaccharides, clays, kaolin clay, attapulgite clay their derivatives and combinations thereof. However, those skilled in the art will appreciate that it is possible to utilize different binding agents without departing from the scope of the present invention. The binding agents are organic in nature or certifiable as organic and are commercially manufactured and available through various companies.

According to an embodiment, the carriers which are used in the organic agricultural composition include, but are not limited to one or more of solid carriers or fillers or diluents. According to another embodiment, the carriers include mineral carriers, plant carriers, water-soluble carriers. However, those skilled in the art will appreciate that it is possible to utilize different carriers without departing from the scope of the present invention. The carriers are commercially manufactured and available through various companies.

The solid carriers include clay such as bentonite, clay, dolomite, kaolin, diatomaceous silicas, talc, natural silicates, starch, modified starch (Pineflow, available from Matsutani Chemical industry Co., Ltd.), plant carriers such as cellulose, starch, sucrose, Lactose, maltodextrin and dextrin. Water insoluble carriers include, but not limited to clays, microcrystalline cellulose, volcanic ash, diatomaceous earth, soap stone, starch. However, those skilled in the art will appreciate that it is possible to utilize different solid carriers without departing from the scope of the present invention. The solid carriers are commercially manufactured and available through various companies.

According to an embodiment, the anticaking agents which are used in organic agricultural composition include, but are not limited to one or more of silica, perlite, mica, talc, soapstone, clays, ester gum, or derivatives or sources thereof. However, those skilled in the art will appreciate that it is possible to utilize different anti-caking agents without departing from the scope of the present invention. The anti-caking agents are commercially manufactured and available through various companies.

According to an embodiment, the antifoaming agents or defoamers which are used in the composition include, but not limited to one or more of silica, silicon dioxide, vegetable oils, petroleum oils, paraffin oil, or derivatives or sources thereof. However, those skilled in the art will appreciate that it is possible to utilize other conventionally known antifoaming agents without departing from the scope of the present invention. The antifoaming agents are commercially manufactured and available through various companies.

According to an embodiment, the sticking agents which are used in the composition include, but not limited to one or more of mineral oils, vegetable oils, petroleum oil, emulsifiers, fish oil or fatty acid soaps or emulsified vegetable oil, cellulose derivatives, natural polymers like xanthan gum. However, those skilled in the art will appreciate that it is possible to utilize other conventionally known sticking agents without departing from the scope of the present invention.

According to an embodiment, the preservatives which are used in the organic agricultural composition include but not limited to, one or more of bactericides, anti-fungal agents, biocides, anti-microbial agents, and antioxidant. Non-limiting examples of preservatives include one or more of potassium sorbate, potassium benzoate, sodium benzoate, paraben, salts or derivatives or sources thereof. However, those skilled in the art will appreciate that it is possible to utilize other conventionally known preservatives without departing from the scope of the present invention. The preservatives are commercially manufactured and available through various companies.

According to an embodiment, the structuring agents which are used in the organic agricultural composition include, but not limited to one or more of thickeners, viscosity modifiers, tackifiers, suspension aids, rheological modifiers or anti-settling agents. The structuring agents comprises one or more of xanthan gum, metal silicates, methylcellulose, polysaccharide, alkaline earth metal silicate, bentonite, attapulgite, kaolin or polyvinyl alcohol. The structuring agents are commercially manufactured and available through various companies. However, those skilled in the art will appreciate that it is possible to utilize other conventionally known structuring agents without departing from the scope of the present invention.

According to an embodiment, the antifreezing agents or freezing point depressants used in the aqueous suspension composition include, but are not limited to one or more of polyhydric alcohols such as propylene glycol, glycerol, glycol ethers, glycol monoethers, carbohydrates such as fructose, galactose, sucrose, lactose, maltose, xylose, arabinose, trehalose, raffinose or derivatives or sources thereof. However, those skilled in the art will appreciate that it is possible to utilize different antifreezing agents without departing from the scope of the present invention. The antifreezing agents are commercially manufactured and available through various companies.

According to an embodiment, the chelating or complexing or sequestering agents which are used in the aqueous suspension composition include, but not limited to one or more of α-hydroxy acids, such as citric acid; fulvic acid, cyclodextrin, humic acid. However, those skilled in the art will appreciate that it is possible to utilize other chelating or complexing or sequestering agents without departing from the scope of the present invention. The chelating or complexing or sequestering agents are commercially manufactured and available through various companies.

According to an embodiment, the penetrant which is used in the aqueous suspension composition include, but not limited to one or more of alcohol, glycol, etc. However, those skilled in the art will appreciate that it is possible to utilize different penetrants without departing from the scope of the present invention. The penetrants are commercially manufactured and available through various companies.

According to an embodiment, the humectant is selected from, but not limited to one or more of propylene glycol, glycerol, and the like. However, those skilled in the art will appreciate that it is possible to utilize other conventionally known humectants without departing from the scope of the present invention. The humectants are commercially manufactured and available through various companies.

It has been surprisingly found that the organic agricultural composition of the present invention has enhanced and improved physical properties of dispersibility, suspensibility, wettability, viscosity, pourability, and provides ease of handling and also reduces the loss of material while handling the product at the time of packaging as well as during field application.

Wettability is the condition or the state of being wettable and can be defined as the degree to which a solid is wetted by a liquid, measured by the force of adhesion between the solid and liquid phases. The wettability of the granular composition is measured using the Standard CIPAC Test MT-53 which describes a procedure for the determination of the time of complete wetting of wettable formulations. A weighed amount of the granular composition is dropped on water in a beaker from a specified height and the time for complete wetting was determined. According to another embodiment, the organic agricultural composition in the form of water dispersible granules or spheronised granules has wettability of less than 2 minutes.

The spheronised granular composition is formulated in a manner such that it is imparted with sufficient hardness which prevents the granules from crumbling during storage and transportation. The hardness exhibited by the granules can be estimated by hardness testers such as the ones provided by Shimadzu, Brinell Hardness (AKB-3000 Model), Mecmesin, Agilent, Vinsyst, Ametek, Erweka, Electrolab, Dr. Schleuniger's pharmatron and Rockwell. According to an embodiment, the hardness exhibited by the granules is at least 1 Newton.

According to an embodiment, the organic agricultural composition in the form of water dispersible granule or suspension passes the wet sieve retention test. The test is used to determine the amount of non-dispersible material in formulations that are applied as dispersions in water. The wet sieve retention value of the agrochemical composition in the form of suspension and granules is measured by using the Standard CIPAC Test MT-185 which describes a procedure for the measuring the amount of material retained on the sieve. A sample of the formulation is dispersed in water and the suspension formed is transferred to a sieve and washed. The amount of the material retained on the sieve is determined by drying and weighing

According to an embodiment, the organic agricultural composition in the form of water dispersible granule or suspension has a wet sieve retention value on a 75-micron sieve of less than 0.5%. According to an embodiment, the organic agricultural composition has a wet sieve retention value on a 75-micron sieve of less than 0.2%. The wet sieve retention value of less than 0.5% indicate that the organic agricultural composition helps in easy application of the formulation preventing clogging of the nozzles or filter equipment.

According to an embodiment, the organic agricultural composition in the form of suspension does not sediment or settle on storage and is easily pourable. This property can be measured in terms of viscosity of the fluid which is a measure of its resistance to gradual deformation by shear stress or tensile stress.

According to an embodiment, viscosity of the liquid composition is determined as per CIPAC MT-192. A sample is transferred to a standard measuring system. The measurement is carried out under different shear conditions and the apparent viscosities are determined. During the test, the temperature of the liquid is kept constant. According to an embodiment, the organic agricultural composition has a viscosity at 25° C. of about 10 cps to about 3000 cps.

According to an embodiment, the suspension composition of the present invention is easily pourable. The pourability is the measure of percent of residue.

According to an embodiment, the pourability of the organic agricultural composition is determined as per CIPAC MT-148.1 by allowing the suspension to stand for 24-hour and the amount remaining in the container after a standardized pouring procedure is determined. The container is rinsed and the amount then remaining is determined and the maximum residue in percent is calculated. According to a further embodiment, the pourability of the organic agricultural composition is less than 5% residue.

Dispersibility of the organic agricultural composition in the form of water dispersible or spheronised granule and suspension is a measure of percent dispersion. Dispersibility is calculated by the minimum percent dispersion. Dispersibility is defined as the ability of the granules to disperse upon addition to a liquid such as water or a solvent. Dispersibility of the granular composition of the present application, was determined as per the standard CIPAC test, MT 174. A known amount of the granular composition was added to a defined volume of water and mixed by stifling to form a suspension. After standing for a short period, the top nine-tenths are drawn off and the remaining tenth dried and determined gravimetrically. The method is virtually a shortened test of suspensibility and is appropriate for establishing the ease with which the granular composition dispersed uniformly in water.

According to an embodiment, the organic agricultural composition has a dispersibility of at least 30%.

According to an embodiment, the organic agricultural composition in the form of water dispersible granule exhibits almost instantaneous dispersion.

According to an embodiment, the organic agricultural composition in the form of spheronised granule makes the actives available instantaneously and also over a longer period which may extend throughout the crop cycle, providing an immediate and sustained release of actives eventually strengthening and protecting the crop at each and every stage of the crop cycle.

According to an embodiment, the organic agricultural composition in the form of granules or suspension exhibits good suspensibility. Suspensibility is defined as the amount of active ingredient suspended after a given time in a column of liquid, of stated height, expressed as a percentage of the amount of active ingredient in the original suspension. The water dispersible granules can be tested for suspensibility as per the CIPAC Handbook, “MT 184 Test for Suspensibility” whereby a suspension of known concentration of the composition in CIPAC Standard Water was prepared and placed in a prescribed measuring cylinder at a constant temperature, and allowed to remain undisturbed for a specified time. The top 9/10ths were drawn off and the remaining 1/10th was then assayed chemically, gravimetrically, or by solvent extraction, and the suspensibility was calculated.

The suspensibility of the suspension is the amount of active ingredient suspended after a given time in a column of liquid, of stated height, expressed as a percentage of the amount of active ingredient in the original suspension. The suspensibility of suspension concentrate is determined as per CIPAC MT-161 by preparing 250 ml of diluted suspension, allowing it to stand in a measuring cylinder under defined conditions, and removing the top nine-tenths. The remaining tenth is then assayed chemically, gravimetrically or by solvent extraction, and the suspensibility is calculated.

According to an embodiment, the organic agricultural composition has a suspensibility of at least 30%.

According to an embodiment, the organic agricultural composition in the form of water dispersible granule or spheronised granule, suspension demonstrates superior stability in terms of suspensibility under accelerated storage condition (ATS). According to an embodiment, the organic agricultural composition demonstrates suspensibility of at least 30% under ATS.

According to an embodiment, the organic agricultural composition demonstrates superior stability towards heat, light, temperature and caking. The composition does not form a hard cake and exhibits enhanced stability even at extended storage under higher temperatures which in turn results in superior field performance. According to further embodiment, the stability exhibited by the organic agricultural composition is at least 6 months.

In describing the below embodiments of the invention, it will be observed that numerous modifications and variations can be effectuated in the process for preparation of organic agricultural composition without departing from the true spirit and scope of the novel concepts of the invention. It is to be understood that no limitation with respect to the specific embodiments illustrated below is intended or should be inferred.

According to an embodiment, the present invention also relates to a process of preparing organic agricultural composition comprising at least one water insoluble macronutrient in its elemental form or salts or complexes or derivatives or sources thereof and at least one hydrocolloid in the form of granules or suspension, wherein the composition has particles in the size range of 0.1 micron to 15 microns; wherein the hydrocolloid has viscosity of ≤400 cps at ≤30% (w/w) aqueous dispersion of the hydrocolloid.

According to an embodiment, the process of preparing organic agricultural composition in granular form, comprising at least one water insoluble macronutrient in its elemental form or salts or complexes or derivatives or sources thereof present in the range of 0.1% w/w to 95% w/w of the total composition, at least one hydrocolloid present in the range of 0.1% w/w to 40% w/w of the total composition; wherein the composition comprises particles in the size range of 0.1 micron to 15 microns; wherein the hydrocolloid has viscosity of ≤400 cps at ≤30% (w/w) aqueous dispersion of the hydrocolloid. The granular organic agricultural composition is in the form of either water dispersible granules, extruded granules, spheronised granules or pellets.

According to an embodiment, the process of preparing organic agricultural composition in the form of suspension, comprising at least one water insoluble macronutrient in its elemental form or salts or complexes or derivatives or sources thereof present in the range of 0.1% w/w to 70% w/w of the total composition, and at least one hydrocolloid present in the range of 0.1% w/w to 30% w/w of the total composition; wherein the composition comprises particles in the size range of 0.1 micron to 15 microns; wherein the hydrocolloid has viscosity of ≤400 cps at ≤30% (w/w) aqueous dispersion of the hydrocolloid.

According to another embodiment, the organic agricultural composition in the form of water dispersible granules or spheronised granules, is made by various techniques such as spray drying, fluidized bed granulation, pan granulation, pin agglomerator, spheronizer, freeze drying etc. The granules can also be extruded through the extruded to obtain extruded granules.

According to an embodiment, the process of preparing a water dispersible granular organic agricultural composition involves milling a blend of at least one water insoluble macronutrient in its elemental form or salts or complexes or derivatives or sources thereof, water and at least one hydrocolloid to obtain slurry or a wet mix. The wet mix obtained is then dried, for instance in a spray dryer, fluid bed dryer or any suitable granulating equipment, followed by sieving to remove the undersized and oversized granules to obtain water dispersible granules of the desired size if required. However, those skilled in the art will appreciate that it is possible to modify or alter or change the process or process parameters to obtain water dispersible granular composition without departing from the scope of the present invention. Water is added to the dried composition and the mixture is blended to obtain a wet mass, which is then extruded through an extruder to obtain the granules of desired size. The wet mass as referred herein also includes dough or paste. The granules can also be formed with hot melt extrusion. However, those skilled in the art will appreciate that it is possible to modify or alter or change the process or process parameters to obtain granular composition without departing from the scope of the present invention.

The granules obtained from the granulator can also be dried in open air or air-dried, to remove any residual moisture, if any. However, those skilled in the art will appreciate that it is possible to modify or alter or change the process or process parameters without departing from the scope of the present invention.

According to another embodiment, the invention further relates to the process for preparing the spheronised granules which involves milling a blend of at least one water insoluble macronutrient in its elemental form or salts or complexes or derivatives or sources thereof, water and at least one hydrocolloid to obtain slurry or a wet mix. The wet mix obtained is then dried, for instance in a spray dryer, fluid bed dryer or any suitable granulating equipment, followed by sieving to remove the undersized and oversized granules to obtain granules. The powder or the fine granules is further subjected to agglomeration in an agglomerator to obtain granules of size 0.05 mm to 6 mm. The agglomerator can include various equipments such as a disc pelletizer or pan granulator, pin agglomerator, spheronizer, or combinations thereof.

According to another embodiment, the invention relates to a process for preparing the organic agricultural suspension composition.

According to an embodiment, the process of preparation of organic agricultural composition in the form of suspension, comprises: homogenizing mixture of at least one water insoluble macronutrient in its elemental form or salts or complexes or derivatives or sources thereof, a liquid vehicle and at least one hydrocolloid to obtain a suspension; and wet milling the obtained suspension to provide composition with a particle size range of 0.1 micron to 15 microns; wherein the hydrocolloid has viscosity of ≤400 cps at ≤30% (w/w) aqueous dispersion of the hydrocolloid. The liquid vehicle is selected from water and/or a water miscible solvent. The water miscible solvent is environmentally safe.

According to an embodiment, the process of preparing an organic agricultural composition in wettable powder form, comprises: milling a blend of at least one water insoluble macronutrient in its elemental form or salts or complexes or derivatives or sources thereof and at least one hydrocolloid; optionally at least one agrochemical excipient to obtain wettable powder composition with desired particle size. However, those skilled in the art will appreciate that it is possible to modify or alter or change the process or process parameters to obtain wettable powder, without departing from the scope of the present invention.

According to an embodiment, the composition of the present invention is at least one of a fertilizer composition, a crop strengthener composition, a nutritional composition, a yield enhancer composition.

According to an embodiment, the invention also relates to improving the crop health and growth, improving the plant nutrition, enhancing the crop yield, strengthening the plant, increasing crop defense, the method comprising treating at least one of seed, crops, a plant, plant propagation material, locus, parts thereof or to the surrounding soil with effective amount of the organic agricultural composition of the present invention in the form of water dispersible granules or spheronised granules, suspension or wettable powder.

The composition is applied through a variety of methods. Methods of applying to the soil include any suitable method, which ensures that the composition penetrates the soil, for example nursery tray application, in furrow application, soil drenching, soil injection, drip irrigation, sprinkler irrigation, seed treatment, seed painting and such other methods. The composition can also be applied in the form of a foliar spray.

The rates of application or the dosage of the composition depends on the type of use, the type of crops, or the specific active ingredients in the composition but is such that the active ingredient, is in an effective amount to provide the desired action (such as crop nutrition, crop protection, crop yield).

From the foregoing it will be observed that numerous modifications and variations can be effectuated without departing from the true spirit and scope of the novel concepts of the present invention. It is to be understood that no limitation with respect to the specific embodiments illustrated is intended or should be inferred.

### A. PREPARATION EXAMPLES

The following examples illustrate the basic methodology and versatility of the composition of the invention. Hydrocolloid exemplified in the preparatory examples can be replaced by any other hydrocolloid thereof. It should be noted that this invention is not limited to these exemplifications.

### A. Water Dispersible Granular Composition of at Least One Water Insoluble Macronutrient and Hydrocolloid.

### Example 1: Water Dispersible Granular (WDG) Composition of 95% Rock Phosphate and 5% Gum Ghatti

Water dispersible granular composition was prepared by blending 95 parts of rock phosphate, and 5 parts of gum ghatti to obtain a blend. The blend obtained was mixed with water in suitable mixing equipment and milled to form a slurry or wet mix.

The wet milled slurry obtained was spray dried at an inlet temperature less than 150° C. and outlet temperature less than 70° C. to get a granular powder. The composition had the following particle size distribution: D10 less than 1 microns; D50 less than 2 microns and D90 less than 4 microns. The granule size of the composition was in the range of 0.05 to 2.5 mm. The composition had dispersibility of 89.1%, suspensibility of 90.1%, wet sieve retention value of 0.06, wettability of less than 30 sec. The composition further demonstrated dispersibility of 85% and suspensibility of about 86% under accelerated storage condition

TABLE 1
The exemplary composition of macronutrient and hydrocolloid in WDG form prepared as per example 1 is tabulated below:

| | | Conc. of | Conc. of | | | | | | | Particle size | | | | | ATS | |
|---|---|---|---|---|---|---|---|---|---|---|---|---|---|---|---|---|
| Ex. | Macronu- | macronutrient | Hydrocolloid (%) | | | | | Excipient | | distribution | | | SS | DP | SS | DP |
| no. | trient | (%) | GA | GK | GG | NG | MG | (%) | Excipient | D10 | D50 | D90 | (%) | (%) | (%) | (%) |
| 2 | Magnesium | 92 | — | — | 8 | — | — | — | — | 0.6 | 2.6 | 5.2 | 86.3 | 82.2 | 84 | 81.1 |
| | oxide | | | | | | | | | | | | | | | |
| 3 | Magnesium | 50 | 15 | — | — | — | — | 35 | Starch 20%, | 0.5 | 2.2 | 4.9 | 90.7 | 88.3 | 89.1 | 86.6 |
| | oxide | | | | | | | | Bentonite 5%, | | | | | | | |
| | | | | | | | | | Lactose 10% | | | | | | | |
| 4 | Magnesium | 20 | — | 5 | — | — | — | 75 | Fulvic | 0.7 | 2.5 | 5.2 | 90.7 | 89.5 | 83.2 | 82.1 |
| | oxide | | | | | | | | acid 5%, | | | | | | | |
| | | | | | | | | | Lactose 30%, | | | | | | | |
| | | | | | | | | | Clay 40% | | | | | | | |
| 5 | Rock | 85 | 10 | — | — | — | — | 5 | Fulvic | 0.4 | 2.0 | 4.2 | 85.1 | 81.2 | 84 | 80.1 |
| | Phosphate | | | | | | | | acid 5% | | | | | | | |
| 6 | Rock | 20 | — | — | — | 15 | — | 65 | Maltodextrin | 0.3 | 1.7 | 3.7 | 91 | 90.2 | 88.1 | 86.2 |
| | Phosphate | | | | | | | | 10%, | | | | | | | |
| | | | | | | | | | Starch 20%, | | | | | | | |
| | | | | | | | | | China clay | | | | | | | |
| | | | | | | | | | 34%, | | | | | | | |
| | | | | | | | | | Silica 1% | | | | | | | |
| 7 | Potassium | 85 | 10 | — | — | — | — | 5 | Fulvic | 0.9 | 2.2 | 5.3 | 72 | 68 | 69.4 | 65 |
| | feldspar | | | | | | | | acid 5% | | | | | | | |
| 8 | Potassium | 90 | — | — | 10 | — | — | — | — | 0.89 | 2.9 | 3.97 | 66 | 63 | 63 | 60 |
| | feldspar | | | | | | | | | | | | | | | |

GA = Gum arabic,
GK = Gum karaya;
GG = Gum Ghatti;
NG = Neem Gum;
MG = Moringa Gum
SS = Suspensibility;
DP = Dispersibility;
WSR = Wet sieve retention value;
ATS = Accelerated Storage Condition

### B. LIQUID SUSPENSION COMPOSITIONS OF WATER INSOLUBLE MACRONUTRIENT AND HYDROCOLLOID

### Example 9: Liquid Suspension Composition of 30% Magnesium Trisilicate and 10% Gum Arabic

Liquid suspension composition was prepared by mixing 30 parts of magnesium trisilicate, 10 parts of gum arabic, 10 parts of glycerol, 0.1 parts of xanthan gum, 1 part of sodium benzoate and water (quantity sufficient) and homogenized by feeding them into a vessel provided with stirring facilities until the total mixture was homogeneous. Subsequently, the suspension obtained was passed through the wet mill to obtain a suspension concentrate with less than 15 microns particle size. The composition had particle size distribution of about D10 less than 0.5 microns; D50 less than 2 microns and D90 less than 4 microns. The sample had suspensibility of about 95%, viscosity of about 320 cps. The composition had suspensibility of about 92% and viscosity of about 340 cps under accelerated storage condition.

### Example 10: Liquid Suspension Composition of 30% Rock Phosphate and 3% Gum Ghatti

Liquid suspension composition was prepared by mixing 30 parts of rock phosphate, 3 parts of gum ghatti, 10 parts of glycerol, 0.1 parts of xanthan gum, 1 part of sodium benzoate and water (quantity sufficient) and homogenized by feeding them into a vessel provided with stirring facilities until the total mixture was homogeneous. Subsequently, the suspension obtained was passed through the wet mill to obtain a suspension concentrate with less than 15 microns particle size. The composition had particle size distribution of about D10 less than 0.5 microns; D50 less than 2.5 microns and D90 less than 6 microns. The sample had suspensibility of about 87%, viscosity of about 350 cps. The composition had suspensibility of about 86% and viscosity of about 370 cps under accelerated storage condition.

### C. WETTABLE POWDER COMPOSITIONS OF WATER INSOLUBLE MACRONUTRIENT AND HYDROCOLLOID

### Example 11: Wettable Powder (WP) Composition of 50% Magnesium Oxide and 5% Gum Arabic

Wettable powder was prepared by mixing 50 parts of magnesium oxide, 5 parts of gum arabic, 20 parts of fulvic acid, and 25 parts of clay to obtain a dry mix. The obtained dry mix was passed through the air jet mill to obtain wettable powder. The obtained wettable powder composition has particle size (D90) of 2.5 microns, a suspensibility of 92%, wettability of 10 seconds, wet sieve retention of 0.11%, and a pH of 6.3

### Bio-Efficacy Data:

To study effect of organic agrochemical composition of at least one water insoluble macronutrient and at least one hydrocolloid according to an embodiment of the present invention:

### Experiment No. 1:

Trial was conducted for the evaluation of the effect of the composition of the present invention on beneficial bacterial and fungal strains in soil for Azotobacter sp., and Trichoderma viride at different concentrations of the composition.

The sterile soil was inoculated with beneficial bacterial and fungal strains in soil for Azotobacter sp., and Trichoderma viride and treated with the composition of the present invention and commercially available macronutrient formulation.

TABLE 2
Effect of the organic agricultural composition of the present invention
on the beneficial bacterial and fungal strains in soil.

| | | Elemental | Cell Population (CFU/gm) | | | | | |
|---|---|---|---|---|---|---|---|---|
| | | Macronutrient | Azotobacter sp. | | | Trichodermaviride | | |
| T. | | applied (gram | | | % | | | % |
| no. | Composition | element/acre) | Day 1 | Day 7 | Change | Day 1 | Day 7 | Change |
| T1 | Magnesium | 3000 | 2.8 × 10⁷ | 3.4 × 10⁷ | 21.42 | 2.3 × 10⁷ | 2.7 × 10⁷ | 17.4 |
| | Oxide 92% | | | | | | | |
| | (Magnesium | | | | | | | |
| | content: 55.2%) + | | | | | | | |
| | Gum arabic 8% | | | | | | | |
| | WG as per | | | | | | | |
| | embodiment of | | | | | | | |
| | the present | | | | | | | |
| | invention @ | | | | | | | |
| | 5.435 kg/acre | | | | | | | |
| T2 | Magnesium | 3000 | 2.7 × 10⁷ | 3.1 × 10⁷ | 14.81 | 2.1 × 10⁷ | 2.4 × 10⁷ | 14.28 |
| | oxide by Incitec | | | | | | | |
| | Pivot | | | | | | | |
| | (Magnesium | | | | | | | |
| | content: 33%) | | | | | | | |
| | Granule | | | | | | | |
| | 9.09 Kg/acre | | | | | | | |
| T3 | Untreated | — | 1.8 × 10⁷ | 1.9 × 10⁷ | 5.55 | 3.3 × 10⁶ | 3.3 × 10⁶ | 0 |

It was noted that treatment T1 appeared to better support the growth of Trichoderma viride and Azotobacter sp. in soil as compared to the commercially available Magnesium Oxide (T2) and untreated control.

Thus, the organic agricultural composition of the present invention in the form of water dispersible granules supports the growth of beneficial microorganisms. The increased presence of beneficial microorganisms helps in increased soil fertility and uptake of soil nutrients.

### Field Trial Data 1: To Study Effect of Water Insoluble Macronutrient and Hydrocolloids on Tomato

The effectiveness of combination of water insoluble macronutrient with hydrocolloids was evaluated in the form of water dispersible granules (WDG) and suspension concentrates (SC), in comparison to application of commercially available macronutrient formulations and an untreated control.

The efficacy trials conducted in India were done in accordance with standard recommended dosages for active ingredients. However, it may be noted that the recommended dosages for each active ingredient may vary as per recommendations in a particular country, soil condition, weather condition and disease incidence. The treatments were carried out following randomized block design (RBD) and keeping all agronomic practices uniform.

The field trials were carried out to see the effect of combination of macronutrient and hydrocolloids on Tomato. The trial was laid out as described below including untreated control, and replicated four times. The crops in trial field was raised following good agricultural practice.

| Details of experiment | Tomato |
|---|---|
| Trial Location | Adgoan, Nasik (MH) |
| Experiment season | Kharif |
| Trial Design | RBD |
| Replications | 04 |
| Treatments | 06 |
| Plot size | 40 m² |
| Method of application | Foliar application |

TABLE 3
Effect of combination of water insoluble macronutrient
and hydrocolloid on yield, shelf life in Tomato

| | | Elemental | | % yield | |
|---|---|---|---|---|---|
| | | Macronutrient | Fruit | increase | Shelf |
| T. | | applied (gram | Yield | over | life |
| No. | Composition | element/acre) | (q/acre) | untreated | (Days) |
| 1 | Magnesium oxide 50% | 2000 | 358.1 | 27.89 | 12.00 |
| | w/w (Mg content: | | | | |
| | 30%) + Gum Arabic | | | | |
| | 15% w/w WDG as per | | | | |
| | an embodiment of the | | | | |
| | invention @ | | | | |
| | 6.665 Kg/acre | | | | |
| 2 | Magnesium oxide (Mg | 2000 | 335.9 | 19.96 | 9.20 |
| | content: 33%) Granule | | | | |
| | by Incitec Pivot | | | | |
| | 6.06 Kg/acre | | | | |
| 3 | Rock phosphate 85% | 800 | 343 | 22.5 | 9.80 |
| | w/w (Phosphorous | | | | |
| | content: 7.5%) + Gum | | | | |
| | Ghatti 15% w/w WG | | | | |
| | as per embodiment of | | | | |
| | the invention @ | | | | |
| | 10.675 Kg/acre | | | | |
| 4 | Ecotika F&F “Rock | 800 | 326 | 16.43 | 9.00 |
| | Phosphate 0-30-0” | | | | |
| | powder (P₂O₅ content: | | | | |
| | 30%; Phosphorous | | | | |
| | content: 2.65%) @ | | | | |
| | 30.18 Kg/acre | | | | |
| 5 | Rock phosphate 30% | 800 | 336 | 20.0 | 9.40 |
| | w/w (Phosphorous | | | | |
| | content: 2.65%) + Gum | | | | |
| | Ghatti 3% w/w SC as | | | | |
| | per an embodiment of | | | | |
| | the invention @ | | | | |
| | 30.18 Kg/acre | | | | |
| 6 | Ecotika F&F “Rock | 800 | 320 | 14.29 | 8.80 |
| | Phosphate 0-30-0” 6% | | | | |
| | w/w SC (prepared as | | | | |
| | per instruction on | | | | |
| | label) (P2O5 content: | | | | |
| | 6%; Phosphorous | | | | |
| | content: 0.53%) @ | | | | |
| | 151 Kg/acre | | | | |
| 7 | Untreated | — | 280 | 0.00 | 6.00 |

It is observed from Table 3, that treatment 1 (T1), treatment T3 (T3) and treatment 5 (T5) showed improved yield of fruit and shelf life in Tomato as compared to commercially available products i.e. treatments T2, T4, T6; and untreated control.

Further, Magnesium oxide 50%+Gum Arabic 15% w/w WDG (Treatment 1) and commercially available Magnesium oxide (Treatment 2) applied to Tomato crop at a dose of 6.665 Kg/acre and 6.06 Kg/acre, exhibited about 27.89% and 19.96% increase in yield respectively over the control. The composition prepared as per embodiment of the present invention showed improved yield of crop as compared to the application of commercially available Magnesium oxide and untreated plot. Further, the composition of the present invention exhibited 6.6% increase in total yield as compared to the yield obtained on application of commercially available Magnesium oxide.

Further, Rock phosphate 85% w/w+Gum Ghatti 15% w/w WG (Treatment 3) and commercially available Rock phosphate (Treatment 4) applied to Tomato crop at a dose of 10.675 Kg/acre and 30.18 Kg/acre, exhibited about 22.5% and 16.43% increase in yield respectively over the control. The composition prepared as per embodiment of the present invention showed improved yield of crop as compared to the application of commercially available Rock phosphate and untreated plot. Further, the composition of the present invention exhibited 5.2% increase in total yield as compared to the yield obtained on application of commercially available Rock phosphate.

Further, Rock phosphate 30% w/w+Gum Ghatti 3% w/w SC (Treatment 5) and commercially available Rock phosphate 6% w/w SC (prepared as per the instructions provided on label) (Treatment 6) applied to Tomato crop at a dose of 30.29 Kg/acre and 151 Kg/acre, exhibited about 20% and 14.29% increase in yield respectively over the control. The composition prepared as per embodiment of the present invention showed improved yield of crop as compared to the application of commercially available Rock phosphate 6% w/w SC (prepared as per the instructions provided on label) and untreated plot. Further, the composition of the present invention exhibited 5% increase in total yield as compared to the yield obtained on application of commercially available Rock phosphate 6% w/w SC (prepared as per the instructions provided on label).

### Field Trial Data 2: Effect of Water Insoluble Macronutrient and Hydrocolloid Composition in a Specific Particle Size on Yield in Sugarcane

The effectiveness of composition of water insoluble macronutrient with hydrocolloids in a specific particle size was evaluated in the form of water dispersible granules (WDG) and an untreated control.

The efficacy trials conducted in India were done in accordance with standard recommended dosages for active ingredients. However, it may be noted that the recommended dosages for each active ingredient may vary as per recommendations in a particular country, soil condition, weather condition and disease incidence. The treatments were carried out following randomized block design (RBD) and keeping all agronomic practices uniform.

The field trials were carried out to see the effect of combination of water insoluble macronutrient and hydrocolloids on Sugarcane. The trial was laid out as described below including untreated control, and replicated four times. The crops in trial field was raised following good agricultural practice.

| Details of experiment | Sugarcane |
|---|---|
| Trial Location | Navsari, Gujarat |
| Experiment season | Kharif |
| Trial Design | RBD |
| Replications | 04 |
| Treatments | 03 |
| Plot size | 50 m² |
| Method of application | Basal application |

TABLE 4
Effect of water insoluble macronutrient and hydrocolloid composition
in a specific particle size on yield in Sugarcane

| | | Range of | Elemental | Total | % yield |
|---|---|---|---|---|---|
| | | Particle | Macronutrient | Cane | increase |
| | | size of the | applied (gram | yield | over |
| Treatment | Composition | composition | element/acre) | (q/acre) | untreated |
| 1 | Rock Phosphate | 0.1 to 15 | 800 | 443.7 | 26.05 |
| | 23% + Gum | microns | | | |
| | Ghatti 16% w/w | | | | |
| | WDG as per an | | | | |
| | embodiment of | | | | |
| | the invention @ | | | | |
| | 39.45 Kg/acre | | | | |
| 2 | Rock Phosphate | 15 to 50 | 800 | 419.1 | 19.06 |
| | 23% + Gum | microns | | | |
| | Ghatti 16% w/w | | | | |
| | WDG as per an | | | | |
| | embodiment of | | | | |
| | the invention @ | | | | |
| | 39.45 Kg/acre | | | | |
| 3 | Rock Phosphate | 50 to 100 | 800 | 413.8 | 17.55 |
| | 23% + Gum | microns | | | |
| | Ghatti 16% w/w | | | | |
| | WDG as per an | | | | |
| | embodiment of | | | | |
| | the invention @ | | | | |
| | 39.45 Kg/acre | | | | |
| 4 | Untreated | — | — | 352 | 0.00 |

It is observed from Table 4, that treatment 1 (T1) having particle size distribution in the range of 0.1 to 15 microns showed improved yield in Sugarcane as compared to treatment 2 (T2) having particle size range of 15-50 microns, and treatment 3 (T3) having particle size distribution in the range of 50-100 microns and untreated control.

Further, Treatment 1 having particle size of 0.1 to 15 microns; Treatment 2 having particle size of 15 to 50 microns; and Treatment 3 having particle size of 50 to 100 microns applied to Sugarcane crop at a dose of 39.45 Kg/acre, exhibited about 26.05%, 19.06% and 17.55% increase in yield respectively over the control.

Thus, it was surprisingly noted that even amongst the WDG formulations, superior efficacy was observed with WDG formulation having specific particle size distribution of 0.1 to 15 microns in comparison to WDG formulations having different particle sizes in varied ranges.

From the foregoing, it will be observed that numerous modifications and variations can be effectuated without departing from the true spirit and scope of the novel concepts of the present invention. It is to be understood that no limitation with respect to the specific embodiments illustrated is intended or should be inferred.

1-21. (canceled)

22. An organic agricultural composition, comprising:
at least one water insoluble macronutrient in elemental form or salts or complexes or derivatives or sources thereof; and
at least one hydrocolloid; wherein the at least one hydrocolloid has a viscosity of less than 400 cps at ≤30% (w/w) aqueous dispersion of the at least one hydrocolloid;
wherein the organic agricultural composition comprises particles in a size range of 0.1 micron to microns.

23. The organic agricultural composition of claim 22, wherein the at least one water insoluble macronutrient is selected from at least one of magnesium, potassium, or phosphorous, and wherein the at least one water insoluble macronutrient is in elemental form or ores or salts or complexes or derivatives or sources thereof.

24. The organic agricultural composition of claim 23, wherein the at least one water insoluble macronutrient is selected from potassium aluminosilicate, feldspar, magnesium oxide, magnesium carbonate, magnesium trisilicate, magnesium silicate, rock phosphate.

25. The organic agricultural composition of claim 22, wherein the at least one hydrocolloid comprises gum arabic, gum karaya, gum ghatti (gum dhawada), larch gum, collagen (fish), Albizia gum, Abelmoschus gum, Almond gum, Bhara gum, Cashew gum, Cordio gum, Grewia gum, Hakea gum, Khaya gum, Katira gum, Kondagogu gum, Leucaena, seed gum, Malva nut gum, Mucuna gum, Moringa gum, Neem gum, Sesbanic gum, or mixtures thereof.

26. The organic agricultural composition of claim 22, wherein the at least one hydrocolloid is selected from gum arabic, gum karaya, gum ghatti, moringa gum, neem gum, or mixtures thereof.

27. The organic agricultural composition of claim 22 in a form of granule, liquid suspension, or wettable powder.

28. The organic agricultural composition of claim 26, wherein granules are water dispersible granules, spheronised granules, extruded granules, or pellets.

29. The organic agricultural composition of claim 22, wherein the organic agricultural composition is in a form of granules; wherein the organic agricultural composition comprises the at least one water insoluble macronutrient in a range of 0.1% w/w to 95% w/w of a total composition, and the at least one hydrocolloid in a range of 0.1% w/w to 40% w/w of the total composition; and wherein the at least one hydrocolloid has a viscosity of less than 400 cps at 30% (w/w) aqueous dispersion of the at least one hydrocolloid.

30. The organic agricultural composition of claim 22, wherein the organic agricultural composition is in a form of liquid suspension; wherein the organic agricultural composition comprises the at least one water insoluble macronutrient in a range of 0.1% w/w to 70% w/w of a total composition, and the at least one hydrocolloid in a range of 0.1% w/w to 30% w/w of the total composition; and wherein the at least one hydrocolloid has a viscosity of less than 400 cps at 30% (w/w) aqueous dispersion of the at least one hydrocolloid.

31. The organic agricultural composition of claim 22, wherein the organic agricultural composition has a particle size distribution (D90) of less than 15 microns and a particle size distribution (D50) of less than 10 microns.

32. The organic agricultural composition of claim 22, wherein a granule size is in a range of 0.05 mm to 6 mm.

33. The organic agricultural composition of claim 22, wherein the organic agricultural composition comprises water dispersible granules, and wherein the water dispersible granules have a granule size in a range of 0.05 mm to 2.5 mm.

34. The organic agricultural composition of claim 22, wherein suspensibility of the organic agricultural composition is at least 30%.

35. The organic agricultural composition of claim 22, wherein dispersibility of the organic agricultural composition is at least 30%.

36. The organic agricultural composition of claim 22, further comprising at least one additional active ingredient selected from biostimulants, plant growth regulator, pesticidal actives and/or fertilizer, or mixtures thereof.

37. The organic agricultural composition of claim 22, wherein the organic agricultural composition is in a form of granules, and wherein the organic agricultural composition further comprises at least one agrochemically acceptable excipient selected from wetting agents, surfactants, emulsifiers, wetting agents, dispersing agents, binders or fillers or carriers or diluent, disintegrating agent, buffer or pH adjuster or neutralizing agent, antifoaming agent, anti-settling agents, anticaking agent, penetrating agent, sticking agent, tackifier, pigments, colorants, stabilizers, and mixtures thereof.

38. The organic agricultural composition of claim 22, wherein the organic agricultural composition is in a form of liquid suspension, and wherein the organic agricultural composition further comprises at least one agrochemically acceptable excipient selected from structuring agent, surfactants, humectants, solvents, water miscible solvents, spreading agent, suspending agents or suspension aid or anti-settling, penetrating agent, sticking agents, drift reducing agents, preservatives, stabilizers, buffers or pH adjusters or neutralizing agents, antifreezing agent or freeze point depressants, antifoaming agents.

39. A process of preparing the organic agricultural composition of claim 22, wherein the organic agricultural composition is in a form of water dispersible granules, the process comprising:
a. milling a blend of: the at least one water insoluble macronutrient in elemental form or salts or complexes or derivatives or sources thereof, water, and the at least one hydrocolloid to obtain a slurry or a wet mix with a particle size range of 0.1 microns to 15 microns; and
b. drying the wet mix to obtain the organic agricultural composition in the form of water dispersible granules; wherein granules of the organic agricultural composition are in a size range of 0.05 mm to 2.5 mm.

40. A process of preparing the organic agricultural composition of claim 22, wherein the organic agricultural composition is in a form of spheronised granules, the process comprising:
a. milling a blend of: the at least one water insoluble macronutrient in elemental form or salts or complexes or derivatives or sources thereof, water, and the at least one hydrocolloid to obtain a slurry or a wet mix with a particle size range of 0.1 microns to 15 microns;
b. drying the wet mix to obtain a water dispersible granular composition; wherein granules of the water dispersible granular composition are in a size range of 0.05 mm to 2.5 mm; and
c. adding water to the dried water dispersible granular composition of step (b), and blending the dried water dispersible granular composition to obtain a dough or a paste, and extruding the dough or the paste through an extruder to obtain extruded granules in a size range of 0.05 mm to 6 mm; or
agglomerating the wet mix or the dried water dispersible granular composition obtained in step (b) in an agglomerator to obtain a granular composition in a size range of 0.05 mm to 6 mm.

41. A process of preparing the organic agricultural composition of claim 22, wherein the organic agricultural composition is in a form of a liquid suspension, the process comprising:
homogenizing a mixture of: the at least one water insoluble macronutrient in elemental form or salts or complexes or derivatives or sources thereof, a liquid vehicle, and the at least one hydrocolloid; and
wet milling obtained suspension to provide the organic agricultural composition.

42. The organic agricultural composition of claim 22, wherein the organic agricultural composition is at least one of a crop strengthener composition, a fertilizer or nutritional composition, a yield enhancer composition.
